(19) United States
(12) Patent Application Publication
(10) Pub. No.: US 2005/0206595 A1
(43) Pub. Date: Sep. 22, 2005

(54) Driving circuit for liquid crystal display device

(76) Inventors: Min Seok Park, Kyoungki-do (KR); Bo Mi Seo, Chungcheongbuk-do (KR)

Correspondence Address: LADAS & PARRY LLP, 224 SOUTH MICHIGAN AVENUE, SUITE 1600, CHICAGO, IL, 60604, US

(21) Appl. No.: 10/951,565

(22) Filed: Sep. 28, 2004

(30) Foreign Application Priority Data
Mar. 17, 2004 (KR) 2004-18081

(51) Int. Cl. G09G 3/36

(52) U.S. Cl. 345/87

(57) ABSTRACT

Disclosed is a driving circuit for a liquid crystal display device capable of effectively reducing electromagnetic interference by significantly reducing the number of transitions of an REV signal. The driving circuit includes a timing controller outputting data signals and control signals to a gate driver IC and a source driver IC. A first flipflop section installed at a rear end of the timing controller and a second flipflop section is installed at a front end of the source driver IC in order to reduce a number of transitions of an REV signal, which represents an inversion or a non-inversion of data transferred between the timing controller and the source driver IC.

### BACKGROUND OF THE INVENTION

1. Field of the invention

The present invention relates to a liquid crystal display device, and more particularly to a driving circuit for a liquid crystal display device capable of effectively reducing EMI (electromagnetic interference).

2. Description of the Prior Art

As electronic communication technologies have been developed, it is possible to fabricate electronic appliances in compact sizes with high-speed and broadband functions, and to operate the electronic appliances with little energy.

However, as chips are highly integrated, chips are sensitively reacted with electromagnetic interference caused by a natural phenomenon, thereby malfunctioning a system.

In addition, such electronic appliances have been widely used in various fields of industry so that a great amount of electromagnetic waves are generated, thereby deteriorating electromagnetic environment and causing a bad influence on a human body. This phenomenon is called “electromagnetic interference (hereinafter, simply referred to as EMI)”.

Studies and researches are currently being carried out in various fields in order to solve the EMI problem. In addition, various solutions have been proposed in the LCD field in order to solve the EMI problem.

For reference, EMI signifies a phenomenon in which an electric field and a magnetic field, which are generated from a conductive wire when high-frequency current is applied to the conductive wire, are propagated into an atmosphere. Such EMI is generated from electronic appliances operating with high-frequency signals.

In a case of an LCD, an operating frequency is increased as resolution of the LCD is increased, so that the EMI is also increased. Accordingly, a driving circuit of the LCD must be designed by considering the EMI. Hereinafter, several examples for reducing the EMI will be described.

First, an EMI filter can be used for reducing the EMI. That is, the EMI filter is inserted into a conductive wire in match with frequency applied to the conductive wire, thereby reducing the EMI.

Second, a PCB is fabricated by using a multi-layer PCB. In this case, the PCB is optimally grounded so that the EMI can be reduced.

Third, frequency applied to the conductive wire can be reduced in order to decrease the EMI. That is, since the EMI is proportional to the frequency applied to the conductive wire, a driver is driven through a division driving method in such a manner that clocks or frequency of data can be reduced.

Fourth, an LVDS (low voltage differential signaling) interface method can be employed in order to reduce the EMI. The LVDS technology is an advanced interface technology, which has lately been put to practical use. According to the LVDS technology, signals are compressed/transmitted through a coding technique, which has been used in a telecommunication field, so that the number of signal lines are significantly reduced and voltage intensity of a digital signal is reduced to less than 1V, thereby reducing an amount of electromagnetic waves causing the EMI.

As mentioned above, various solutions have been proposed in the LCD field in order to reduce the EMI. Among those solutions, a representative solution is a method for reducing the EMI generated from a data transferring signal between a timing controller and a driver IC.

Since EMI components may be increased as the number of data inversions increases, the EMI can be reduced if the number of data inversions decreases. Herein, the term “data inversion” refers to an inversion of digital data from 0 to 1, or from 1 to 0.

Meanwhile, a TDDI (transition dependent data inversion) driving method is one of LCD driving methods used for reducing the EMI. According to the TDDI driving method, after detecting the number of data transitions (0→1, or 1→0), data are transmitted while being inversed from 0 to 1 or from 1 to 0 if a predetermined number of data has been transited, and an REV signal representing the data inversion is set to “1” so as to represent the data inversion.

FIG. 1 shows a data transfer between the timing controller and the source driver IC when the TDDI driving method is not used.

Referring to FIG. 1, “B” represents black data, and “W” represents white data. In addition, in a case of a 6-bit source driver IC, R, G and B data have 6-bit, respectively. However, R data are only shown in FIG. 1 for convenience.

Meanwhile, FIG. 2 shows a data transfer between the timing controller and the source driver IC when the TDDI driving method is used.

Referring to FIG. 2, when the TDDI driving method is used, an REV signal representing the data inversion is added in order to inform a worker of the data inversion. Although an REV signal line is additionally required, the number of data transitions can be significantly reduced, thereby reducing the EMI.

However, although the EMI can be reduced when the TDDI driving method is used, a great number of transitions of the REV signal may still exist.

### SUMMARY OF THE INVENTION

Accordingly, the present invention has been made to solve the above-mentioned problems occurring in the prior art, and a first object of the present invention is to provide a driving circuit for a liquid crystal display device capable of effectively reducing EMI by significantly reducing the number of REV transitions.

In order to accomplish the object, there is provided a driving circuit for a liquid crystal display device, the driving circuit comprising a timing controller outputting data signals and control signals to a gate driver IC and a source driver IC, wherein a first flipflop section installed at a rear end of the timing controller and a second flipflop section is installed at a front end of the source driver IC in order to reduce a number of transitions of an REV signal, which represents an inversion or a non-inversion of data transferred between the timing controller and the source driver IC.

According to the preferred embodiment of the present invention, each of the first and second flipflop sections includes a T-flipflop.

According to the preferred embodiment of the present invention, the REV signal outputted from the timing controller is inputted into the first flipflop section so that the REV signal is converted into an RT signal, the RT signal is inputted into the second flipflop section so that the RT signal is again converted into the REV signal, and the REV signal outputted from the second flipflop section is inputted into the source driver IC.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view showing a data transfer between a timing controller and a source driver IC when a TDDI driving method is not used;

FIG. 2 is a schematic view showing a data transfer between a timing controller and a source driver IC when a conventional TDDI driving method is used;

FIG. 3 is a block view showing a driving circuit for a liquid crystal display device according to one embodiment of the present invention;

FIG. 4 is a view for explaining a T-flipflop characteristic according to one embodiment of the present invention; and

FIG. 5 is a schematic view showing a data transfer between a timing controller and a source driver IC when a TDDI driving method is used according to one embodiment of the present invention.

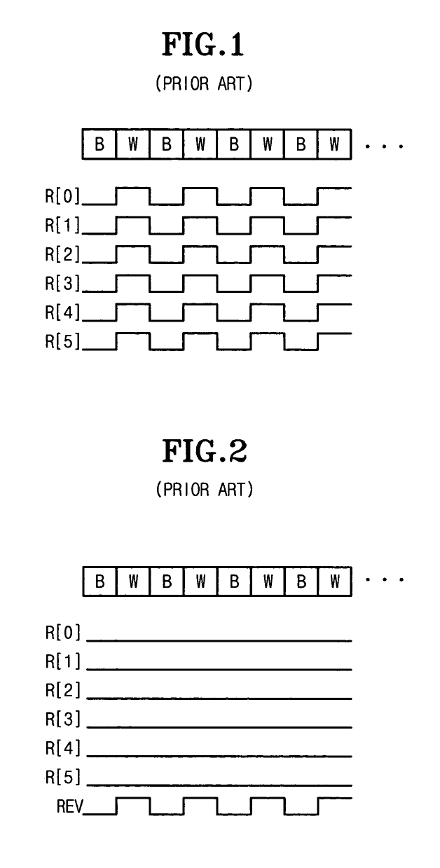

### DETAILED DESCRIPTION OF THE PREFERRED EMBODIMENTS

Hereinafter, a driving circuit for a liquid crystal display device according to one embodiment of the present invention will be described with reference to accompanying drawings.

According to the present invention, a flipflop section, preferably, a T-flipflop section is provided between an output section of a timing controller and an input section of a source driver IC in order to significantly reduce the number of REV transitions.

Hereinafter, the present invention will be described in detail.

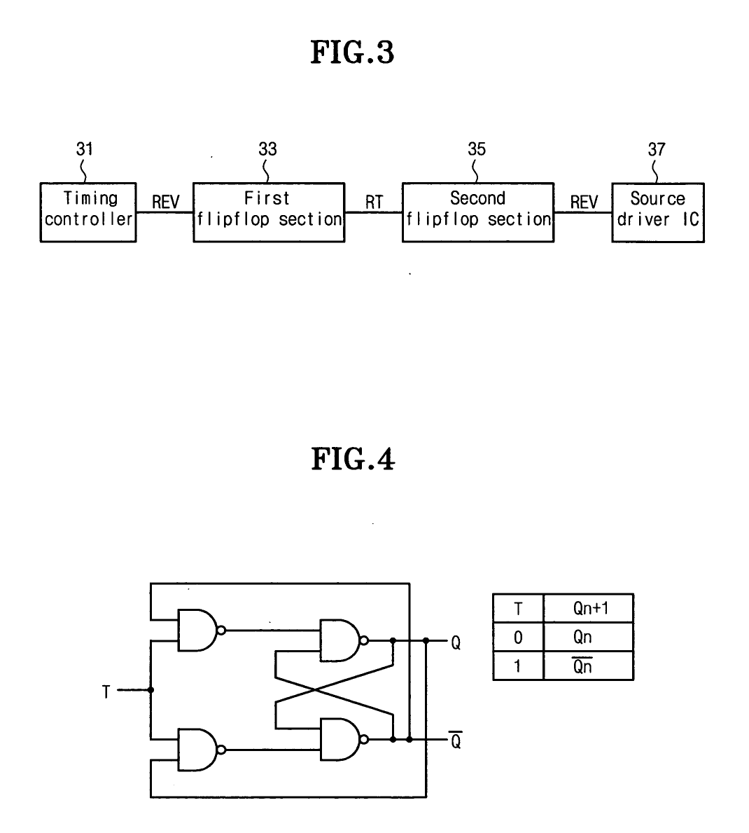

FIG. 3 is a block view showing a driving circuit for a liquid crystal display device according to one embodiment of the present invention.

As shown in FIG. 3, the driving circuit for the liquid crystal display device of the present invention includes a timing controller 31 for outputting REV signals, a first flipflop section 33 receiving the REV signals outputted from the timing controller 31 and outputting RT signals after logically calculating the REV signals, a second flipflop section 35 receiving RT signals outputted from the first flipflop section 33 and outputting the REV signals after logically calculating the RT signals, and a source driver IC 37 for receiving REV signals outputted from the second flipflop section 35.

Preferably, each of the first and second flipflop sections includes a T-flipflop section having a basic characteristic in which an output thereof is varied depending on an input thereof, as shown in FIG. 4.

According to the driving circuit of the liquid crystal display device having the above construction, when the REV signal, which represents an inversion or a non-inversion of data transferred to the source driver IC 37, is outputted from the timing controller 31, the REV signal is inputted into the first flipflop section 33 and the first flipflop section 33 outputs an RT signal by converting the RV signal.

The RT signal outputted from the first flipflop section 33 is again inputted into the second flipflop section 35 so that the RT signal is converted into the REV signal. Then, the REV signal is inputted into the source driver IC 37.

Herein, the RT signal means a signal transferred between the timing controller 31 and the source driver IC 37 in order to represent whether or not the REV signal has been transited.

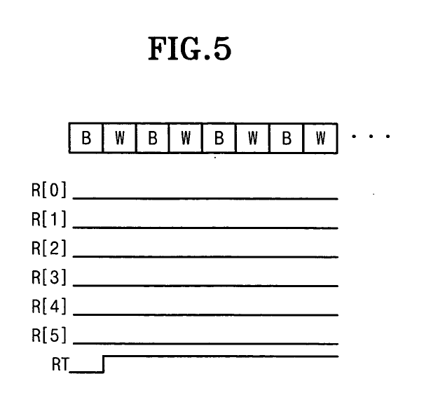

FIG. 5 shows a signal transferred between the timing controller and the source driver IC in the driving circuit having a construction as shown in FIG. 3.

If the RT signal is used, instead of directly using the REV signal, the number of transitions of the signal may be significantly reduced. That is, as compared with the number of transitions of the REV signal shown in FIG. 2, the number of transitions of the RT signal shown in FIG. 5 is significantly reduced.

As mentioned above, according to the TDDI driving method, the EMI is reduced as the number of signal transitions becomes reduced. Therefore, since the number of transitions of the RT signal shown in FIG. 5 is significantly reduced as compared with the number of transitions of the REV signal shown in FIG. 2, the EMI may be reduced.

As described above, the liquid crystal display device according to the present invention has the following advantage.

According to the present invention, a first flipflop section is formed at a rear end of a timing controller and a second flipflop section is formed at a front end of a source driver IC in such a manner that an REV signal is converted into an RT signal, and then, the RT signal is again converted into the REV signal. Thus, even if the TDDI driving method is used, the number of transitions of the REV signals can be significantly reduced so that the EMI can be reduced.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A driving circuit for a liquid crystal display device, the driving circuit comprising:
a timing controller outputting data signals and control signals to a gate driver IC and a source driver IC, wherein a first flipflop section installed at a rear end of the timing controller and a second flipflop section is installed at a front end of the source driver IC in order to reduce a number of transitions of an REV signal, which represents an inversion or a non-inversion of data transferred between the timing controller and the source driver IC.

2. The driving circuit as claimed in claim 1, wherein each of the first and second flipflop sections includes a T-flipflop.

3. The driving circuit as claimed in claim 1, wherein the REV signal outputted from the timing controller is inputted into the first flipflop section so that the REV signal is converted into an RT signal, the RT signal is inputted into the second flipflop section so that the RT signal is again converted into the REV signal, and the REV signal outputted from the second flipflop section is inputted into the source driver IC.
